(19) United States
(12) Patent Application Publication
(10) Pub. No.: US 2005/0098911 A1
(43) Pub. Date: May 12, 2005

(54) Mold protection system and method

(76) Inventor: Neil Alex Korneff, Diamond Bar, CA (US)

Correspondence Address: Neil Alex Korneff, 21428 Bella Pine Drive, Diamond Bar, CA, 91766, US

(21) Appl. No.: 10/703,873

(22) Filed: Nov. 8, 2003

(51) Int. Cl. B29C 45/76

(52) U.S. Cl. 264/40.1; 264/406; 264/334; 264/335; 264/328.1

(57) ABSTRACT

An injection-molding machine includes various devices for protecting the mold from closing on molded articles. A method for protecting the mold from closing on articles, or portions thereof, is disclosed. This detection system and method self-determines the amount of inspection zones being utilized by the mold and the function of each zone. Zones can have sensors performing either drop monitoring or article detection. The conditions of each of the zones prior to ejection and the conditions of each of the zones after ejection of a master cycle are recorded. The conditions of each of the zones prior to ejection and the conditions of each of the zones after ejection of subsequent cycles are compared to the conditions of the master cycle. If all zones were at least temporarily satisfied, and the current and master cycles have identical conditions prior to ejection and after ejection, the mold is allowed to close.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to a system and method for protecting injection molds.

2. Prior Art

Articles molded in an injection mold may not eject from the mold's ejection sequences. The inherent characteristics of the material being molded, the geometry of the article, or molding imperfections, such as flash, often cause an unsuccessful ejection. Portions of molded articles may remain in the mold after the ejection sequences due to a failure in the ejection system, breakage of the molded article, or insufficient material being supplied to the mold cavity. If the molded articles, or portions thereof, are not properly ejected from the mold prior to the mold closing, mold damage can occur or subsequent molded articles may be defective. Molding machines are often equipped with a low-pressure mold protection feature, closing the mold at a lower pressure in an attempt to detect any resistance at mold closing due to an unwanted article in the mold. Low-pressure mold protection does not protect the mold when the low pressure is enough to damage the mold, or when improper ejection occurs often.

Article-sensing vision systems and radiation emitting and receiving article sensors are currently utilized to protect injection molds. Radiation emitting and receiving article sensors are often utilized to function as drop sensors or article detection sensors. Drop sensors are utilized to verify that a molded part fell, or dropped, past the sensor, providing a high degree of confidence that the molded part cleared the mold. Article-detection sensors detect the absence or presence of an article in the mold. Molds equipped with mold protection sensors vary in the amount of monitored zones and the functions the zones perform. These zones may be performing drop monitoring or article detection within the mold. Article-detection controllers require operator intervention to set the amount of monitored zones and define the function of each zone. This requirement for operator intervention is undesirable since an incorrect setup can lead to improper protection of the mold. This risk can be mitigated through the purchase of multiple article-detection controllers, dedicating each controller to a specific mold, or group of molds, with a predetermined amount of utilized zones with each zone being predetermined whether it is performing drop monitoring or article sensing.

Protecting the mold, eliminating the need for dedicated controllers, simplifying mold installations, and reducing the risk of improper mold protection are important since prevention of mold damage directly relates to the cost of the molded articles and the competitiveness of the molder.

### OBJECTS AND ADVANTAGES

Accordingly, several objects and advantages of my invention are:
(a) a reduction in risk by eliminating the need for an operator to define the amount of zones being monitored by the article-detection controller,
(b) a reduction in risk by eliminating the need for an operator to define whether zones are performing drop monitoring or article sensing,
(c) a reduction in capital by not requiring the use of dedicated article-detection controllers for specific molds in an effort to mitigate risk,
(d) protection of the mold from closing on molded articles, or portions thereof
(e) better quality by ensuring molded articles, or portions thereof, are properly ejected, not compromising the integrity of subsequent molded articles,

Further objects and advantages of my invention will become apparent from a consideration of the drawings and ensuing description.

### SUMMARY

This invention provides a system and method of protecting a mold.

### DRAWINGS

FIG. 1 is a perspective view of a mold equipped with article-detection devices;

FIG. 2 is a horizontal section view of the mold equipped with a through-beam radiation emitting and receiving article sensor;

FIG. 3 is a horizontal section view of the mold equipped with a reflective radiation emitting and receiving article sensor.;

FIG. 4 is a vertical section view of the mold equipped with a drop monitoring reflective radiation emitting and receiving sensor;

FIG. 5 is a diagram employing the mold protection method and system which forms the embodiment of the present invention.

### DRAWING REFERENCE NUMERALS

10 Ejector-half of injection mold
12 Hot-half of injection mold
14 Drop monitoring reflective radiation emitting and receiving sensor
16 Through-beam radiation receiving sensor
18 Through-beam radiation emitting sensor
20 Reflective radiation emitting and receiving sensor
22 Mold ejector system
24 Article-detection controller
26 Molding machine controller
28 Connecting device
30 Molded article, or portion of an article
32 Radiation beam
34 Start of sequence
36 Receive “Mold Open” signal from injection-molding machine
38 Record the condition of zones prior to part ejection
40 Master record of zone conditions prior to ejection
42 Prevent mold from closing
44 Have all unsatisfied zones become at least temporarily satisfied?
46 Record the condition of zones after ejection
48 Master record of zone conditions after ejection
50 Enable mold to close
52 Current record of zone conditions prior to ejection
54 Current record of zone conditions after ejection
56 Do current and master records for zone conditions after ejection match?
58 Do current and master records for zone conditions prior to ejection match?
60 Error

### DETAILED DESCRIPTION

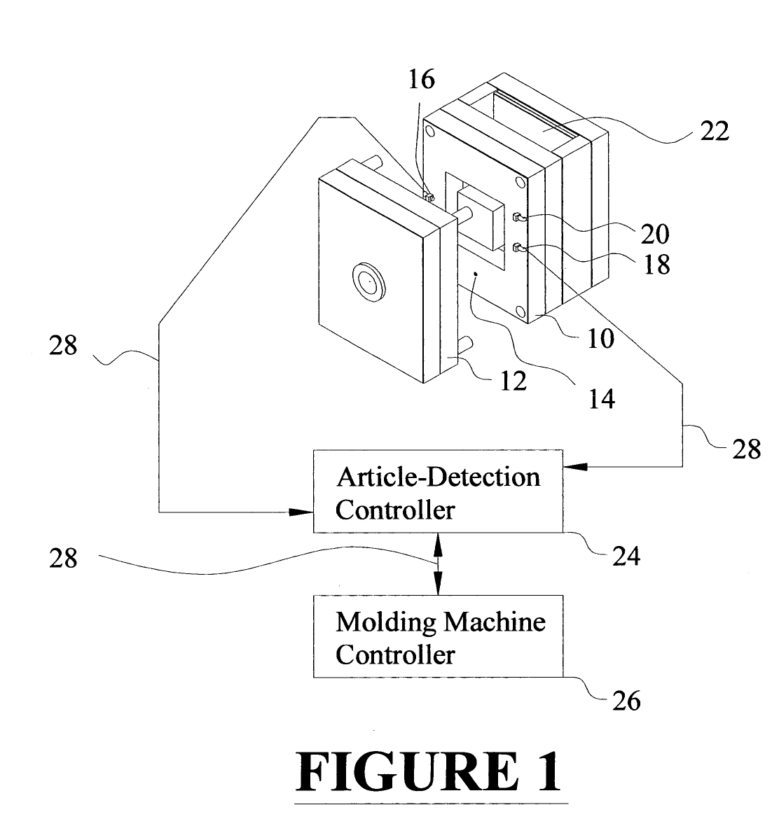

FIG. 1 depicts a system for detecting the presence of an article, or portion thereof 30, in a mold. A drop monitoring reflective radiation emitting and receiving sensor 14, a through-beam radiation receiving sensor 16, a through-beam radiation emitting sensor 18, and a reflective radiation emitting and receiving sensor 20 are attached to the ejector-half of the mold 10. Article-detection devices are not limited to radiation emitting and receiving sensors 14, 16, 18, 20. The simultaneous use of multiple article-sensing systems such as radiation emitting and receiving article sensors 14, 16, 18, 20 as depicted in FIG. 1 is not required. The article-sensing radiation emitting and receiving article sensors 14, 16, 18, 20 are electrically connected to the article-detection controller 24. The article-detection controller 24 is connected to the molding machine controller 26. The connecting device 28 between the article-sensing devices 14, 16, 18, 20, the article-detection controller 24, and the molding machine controller 26 could be any connecting device known to the ordinarily skilled artisan such as, and not limited to, electrical cords, wiring, cables, or fiber optic cables.

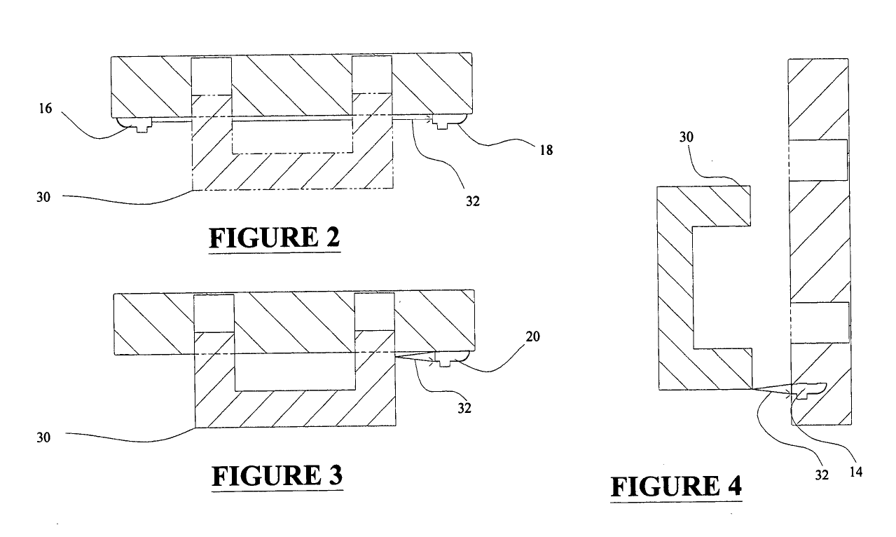

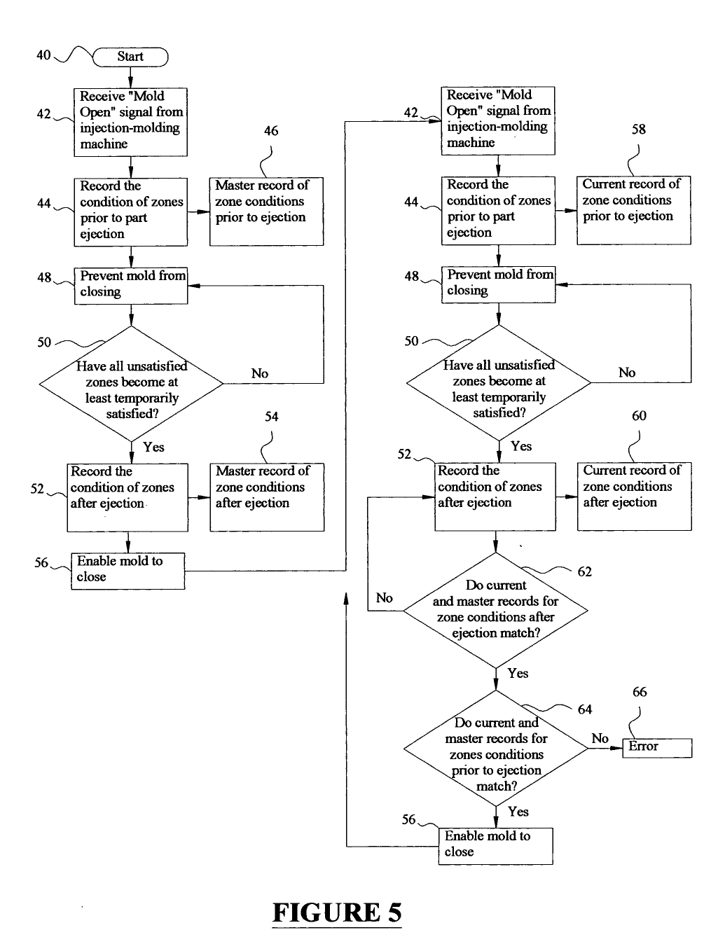

FIG. 2 illustrates how an article, or portion thereof 30, not ejected from the mold would be detected by through-beam radiation receiving and emitting sensors 16, 18. The improperly ejected article, or portion thereof 30, interferes with the radiation beam 32 emitted from the through-beam radiation emitting sensor 18, preventing the through-beam radiation receiving sensor 16 from detecting the radiation beam 32. FIG. 3 illustrates how an article, or portion thereof 30, not ejected from the mold would be detected by a reflective radiation emitting and receiving sensor 20. FIG. 4 illustrates how an article, or portion thereof 30, would be detected by a drop monitoring reflective radiation emitting and receiving sensor 14. The radiation emitters and receivers 14, 16, 18, 20 could be any device known to the ordinarily skilled artisan and could be, and not limited to, infrared light sources, white light sources, light emitting diodes, photoresistors, photodiodes, phototransistors, or photovoltaic cells. These devices also include appropriate lenses to increase detecting distances and modify the detection area. FIG. 5 is a diagram employing the mold protection method and system which forms the embodiment of the present invention.

Operation—FIG. 1

Article-detection devices, such as radiation emitting and receiving article sensors 14, 16, 18, 20, are strategically placed in the mold to detect a molded article, or portion thereof 30 at known positions. Placing sensors that inspect below the molding position enable the sensors to perform drop monitoring 14, detecting the molded article, or portion thereof 30, as it falls from the mold. Sensors that inspect the molding position enable the sensors to perform article detection 16, 18, 20, detecting the molded article, or portion thereof 30, that is in the mold.

The article-detection controller 24 monitors the condition of all zones and permits or prohibits the molding machine controller 26 from closing the mold and initiating the next molding cycle. The mold ejector system 22 is utilized to eject the part from the ejector-half of the injection mold 10, and can encompass all methods of ejection known to the ordinarily skilled artisan such as, and not limited to, mechanical ejection and pneumatic ejection. If all drop monitoring sensors 14 have been satisfied, and the molded article, or portion thereof 30, is not detected by the article-detection devices 16, 18, 20, the mold is allowed to close and start its next cycle. If all drop monitoring sensors 14 have not been satisfied, or the molded article, or portion thereof 30, is detected by the article-detection devices 16, 18, 20, the mold is not allowed to close and start its next cycle.

Operation—FIG. 5

Prior to part ejection, the molded article, or portion thereof 30, will be located in the molding area and all monitoring zones will be unsatisfied. The conditions of zones prior to part ejection are recorded 44 since any unsatisfied zone is being utilized for part monitoring. Any unutilized zones are jumped and are permanently satisfied, and therefore are satisfied prior to part ejection. The mold is prevented from closing 48 and initiating the next cycle. After all unsatisfied zones have become at least temporarily satisfied 50, the condition of zones after ejection are recorded 52. An article-detecting zone will remain satisfied after part ejection, while drop-monitoring zones will only be momentarily satisfied. The mold will then be allowed to close 56. During the master cycle, the record of zone conditions prior to part ejection 44 are recorded as a master record of zone conditions prior to ejection 46. During this master cycle, the record of zone conditions after ejection 52 are recorded as the master record of zone conditions after ejection 54. The master cycle does not necessarily have to be the first cycle, but can be any prior cycle to the current cycle. When the master cycle is defined by the article-detection controller, only passive operator supervision is required to ensure that the mold and mold protection system performed satisfactorily during this master cycle. Any subsequent cycles to the master cycle then record the current record of zone conditions prior to ejection 58 and the current record of zone conditions after ejection 60, enabling a comparison with the master records 46, 54. The current and master records of zone conditions after ejection are compared 62, and if they match, the current and master records for zone conditions prior to ejection are compared 64. If all unsatisfied zones have become at least temporarily satisfied, and both comparisons match, the mold is allowed to close 56, starting the next molding cycle.

From the description above, a number of advantages of the system become evident:
a) A reduction in risk by enabling the article-detection controller to determine the amount of zones being monitored;
b) A reduction in risk by enabling the article-detection controller to determine whether the monitoring zones are performing article sensing or drop monitoring functions;
c) The ability of the article-detection controller to only require passive supervision at start-up;
d) A reduction of capital by enabling the article-detection controller to be versatile, able to control different amounts of zones and recognize the monitoring functions of those zones;
e) Better quality by ensuring molded articles, or portions thereof, are properly ejected, not compromising the integrity of subsequent molded articles

These advantages enable a lower risk and reduction of capital than with existing mold protection methods.

Although the description above contains many specifics, these should not be construed as limiting the scope of the invention, but as merely providing illustrations of some of the presently preferred embodiments of this invention. For example, the article-detection controller and molding-machine controller can be one and the same, wireless communications can be utilized to communicate between the devices, the master cycle need not be the first cycle, etc. The scope of the invention should be determined by the appended claims and their legal equivalents, rather than by the examples given.

1. A method of performing mold protection comprising the steps of:
a) Detecting the presence of a molded article, or portion thereof, in an injection mold with one or more inspection zones;
b) Recording the conditions of said inspection zones prior to ejection;
c) Recording the conditions of said inspection zones after ejection;
d) Comparing said conditions of inspection zones prior to ejection with the conditions of said inspection zones prior to ejection from a previous molding cycle;
e) Comparing said conditions of inspection zones after ejection with the conditions of said inspection zones after ejection from a previous molding cycle;
i) Enabling the next molding cycle to initiate if:
i. Said conditions of inspection zones prior to ejection and said conditions of inspection zones prior to ejection from a previous molding cycle match, and
ii. Said conditions of inspection zones after ejection and said conditions of inspection zones after ejection from a previous molding cycle match.

2. The condition of a predetermined number of unutilized said inspection zones of claim 1, are permanently set.

3. The method of detecting the presence of said molded article, or portion thereof, of claim 1 is accomplished with one or more radiation emitting and receiving sensors.

4. The method of detecting the presence of said molded article, or portion thereof, of claim 1 detects the presence of said molded article, or portion thereof, in said injection mold and portions of the mold which are not in position prior to initiating said next cycle.

5. Said article, or portion thereof, of claim 1 is the molded part.

6. Said article, or portion thereof, of claim 1 is a byproduct of molding the part.

7. Said ejection of claim 1 is a mechanical ejection.

8. Said ejection of claim 1 is a pneumatic ejection.

9. Said injection mold of claim 1 is a plastic-injection mold.

10. Said injection mold of claim 1 is a metal-injection mold.

11. Said injection mold of claim 1 is a silicon-injection mold.

12. Said molded article, or portion thereof, of claim 1 is a plastic-injection molded article, or portion thereof.

13. Said molded article, or portion thereof, of claim 1 is a metal-injection molded article, or portion thereof.

14. Said molded article, or portion thereof, of claim 1 is a silicon-injection molded article, or portion thereof.
